(19) United States
(12) Patent Application Publication
(10) Pub. No.: US 2023/0351284 A1
(43) Pub. Date: Nov. 2, 2023

(54) SYSTEMS AND METHODS FOR RESOURCE ALLOCATION OPTIMIZATION

(71) Applicant: BIRDSEYE GLOBAL INC., Toronto (CA)

(72) Inventors: Matthew Bogoroch, Toronto (CA); Shardul Frey, Toronto (CA)

(21) Appl. No.: 17/847,687

(22) Filed: Jun. 23, 2022

Related U.S. Application Data
(60) Provisional application No. 63/337,387, filed on May 2, 2022.

(51) Int. Cl. G06Q 10/06

(52) U.S. Cl. CPC G06Q 10/06315; G06Q 10/06393

(57) ABSTRACT

An example server for resource allocation optimization amongst a plurality of allocation targets includes: a memory and a communications interface; and a processor interconnected to the memory and the communications interface, the processor configured to: obtain a revenue model associated with an account, the revenue model trained based on a historical resource allocation and revenue for the account; extract, from the revenue model, coefficients corresponding to each of the allocation targets; define, using the extracted coefficients, a symbolic representation of the revenue model; define target constraints for each of the allocation targets based on resource allocation constraints, the target constraints expressed as symbolic representations; apply Lagrangian optimization to the symbolic representation of the revenue model and the target constraints to obtain a set of stationary points; evaluate each of the stationary points from the set to select a stationary point optimizing the revenue model, the selected stationary point defining a resource allocation for each of the allocation targets; and allocate, for each of the allocation targets, resources according to the resource allocation defined by the stationary point.

### FIELD

The specification relates generally to optimization systems, and more particularly to a system and method for resource allocation optimization.

### BACKGROUND

Businesses may spend considerable resources, including budgetary resources, as well as time to develop and distribute social media content or other freeform outreach to reach potential consumers to develop business and increase revenue. However, it may be difficult to determine the effectiveness of various campaigns or provisioning of resources, as well as the optimal way to allocate resources to optimize business and revenue.

### SUMMARY

According to an aspect of the present specification an example server for resource allocation optimization amongst a plurality of allocation targets includes: a memory and a communications interface; and a processor interconnected to the memory and the communications interface, the processor configured to: obtain a revenue model associated with an account, the revenue model trained based on a historical resource allocation and revenue for the account; extract, from the revenue model, coefficients corresponding to each of the allocation targets; define, using the extracted coefficients, a symbolic representation of the revenue model; define target constraints for each of the allocation targets based on resource allocation constraints, the target constraints expressed as symbolic representations; apply Lagrangian optimization to the symbolic representation of the revenue model and the target constraints to obtain a set of stationary points; evaluate each of the stationary points from the set to select a stationary point optimizing the revenue model, the selected stationary point defining a resource allocation for each of the allocation targets; and allocate, for each of the allocation targets, resources according to the resource allocation defined by the stationary point.

According to another aspect of the present specification, an example method for resource allocation optimization amongst a plurality of allocation targets includes: obtaining a revenue model associated with an account, the revenue model trained based on a historical resource allocation and revenue for the account; extracting, from the revenue model, coefficients corresponding to each of the allocation targets; defining, using the extracted coefficients, a symbolic representation of the revenue model; defining target constraints for each of the allocation targets based on resource allocation constraints, the target constraints expressed as symbolic representations; applying Lagrangian optimization to the symbolic representation of the revenue model and the target constraints to obtain a set of stationary points; evaluating each of the stationary points from the set to select a stationary point optimizing the revenue model, the selected stationary point defining a resource allocation for each of the allocation targets; and allocating, for each of the allocation targets, resources according to the resource allocation defined by the stationary point.

According to another aspect of the present specification, an example system for resource allocation optimization amongst a plurality of allocation targets includes: a revenue database storing revenue data for at least one account; a resource allocation database storing resource allocation data for the account; a model database storing revenue models for the account, the revenue models trained based on the revenue data and the resource allocation data; and a server configured to: obtain a revenue model from the model database; extract, from the revenue model, coefficients corresponding to each of the allocation targets; define, using the extracted coefficients, a symbolic representation of the revenue model; define target constraints for each of the allocation targets based on resource allocation constraints, the target constraints expressed as symbolic representations; apply Lagrangian optimization to the symbolic representation of the revenue model and the target constraints to obtain a set of stationary points; evaluate each of the stationary points from the set to select a stationary point optimizing the revenue model, the selected stationary point defining a resource allocation for each of the allocation targets; and allocate, for each of the allocation targets, resources according to the resource allocation defined by the stationary point.

### BRIEF DESCRIPTION OF DRAWINGS

Implementations are described with reference to the following figures, in which:

FIG. 1 depicts a schematic block diagram of an example system for resource allocation optimization;

FIG. 2 depicts a block diagram of certain internal components of the server of FIG. 1;

FIG. 3 depicts a flowchart of an example method of resource allocation optimization;

FIG. 4 depicts a schematic diagram of an example interface for resource allocation optimization;

FIG. 5 depicts a flowchart of an example method of computing effectiveness metrics;

FIGS. 6A and B depict schematic diagrams of example interfaces displaying effectiveness metrics; and

FIG. 7 depicts a flowchart of an example method of selecting the stationary point optimizing the revenue model at block 330 of the method of FIG. 3.

### DETAILED DESCRIPTION

In accordance with the present disclosure, a system and method are provided to improve resource allocation optimization. In particular, the system and method use an analytical approach to obtain a well-constrained sample space, as compared to traditional simulations which may typically run hundreds or thousands of simulations to determine the optimal solution. The method may therefore reduce the computational burden on the system while providing an output indicating an optimal resource allocation amongst a plurality of providers (i.e., allocation targets) to optimize revenue. Additionally, the system may use time series correlations to provide a broad measure of effectiveness of certain campaigns or other resource efforts.

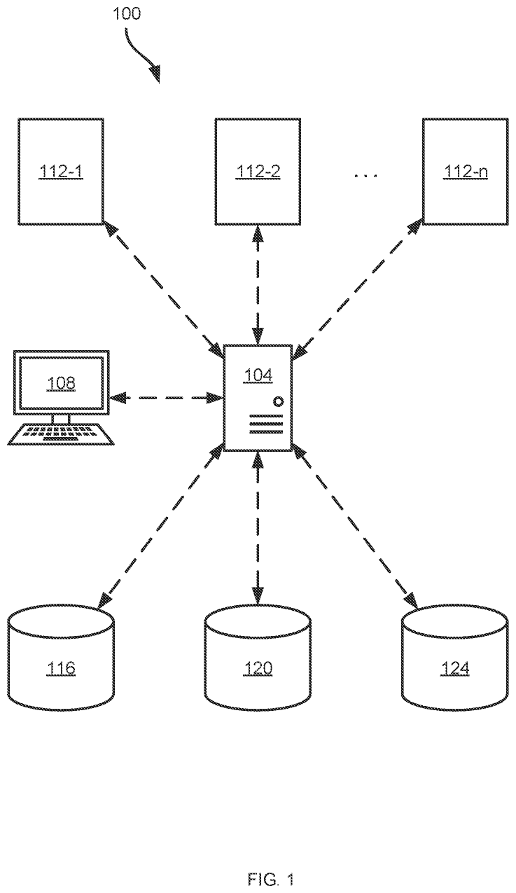

FIG. 1 depicts a system 100 for resource allocation optimization. The system 100 includes a server 104 interconnected with a client device 108 and a plurality of third-party service provider platforms 112-1, 112-2, through to 112-n (referred to herein generically as a platform 112, and collectively as platforms 112; this nomenclature is also used elsewhere herein) are shown.

The server 104 is generally configured to optimize allocation of a resource supply, such as a budgetary amount, as will be described in greater detail below. The server 104 may be any suitable server environment, including a series of cooperating servers, a cloud-based server, and the like. The internal components of the server 104 will be described in greater detail below. The server 104 is in communication with the client device 108, and the platforms 112 via one or more communication links, shown in the present example as being wireless communication links. The communication links may be wired, wireless, a combination thereof, and may traverse one or more networks, including local area networks, wide area networks, the internet, and the like.

The client device 108 is generally configured to interact with the server 104 and to engage a user in the resource allocation optimization operation, for example by displaying the results, of the optimization, presenting forecasts and other metrics, and the like. The client device 108 may be operated by an entity wishing to optimize a resource supply. For example, a business may operate the client device 108 to engage the server to optimize a marketing budget. In other examples, the client device 108 may be operated by other entities or to optimize a different type of quantifiable resource supply.

The client device 108 may be a computing device such as a laptop computer, desktop computer, tablet, mobile phone, kiosk, or the like. The client device 108 may implement a web browser application to access a site hosted at the server 104 enabling the functionality described herein. In other examples, the client device 108 may implement a client application which cooperates with the server 104 to implement the functionality described herein. The client device 108 includes a suitable processor and memory storing machine-readable instructions which, when executed, causes the client device 108 to perform the functionality described herein. The client device 108 also includes a suitable communications interface (e.g., including transmitters, receivers, network interface devices, and the like) to communicate with other computing devices, such as the server 104.

The third-party service provider platforms 112 may be servers, cloud-based systems, or the like, supporting functionality provided by third-party service providers. Generally, the third-party service providers (also referred to herein simply as providers) may provide services to the entity operating the client device 108. In some examples, the service more generally provided by the third-party service provider may be different from the services provided to the entity operating the client device 108. For example, the service provider may be a social media platform, and may provide to the entity operating the client device 108, a platform on which to purchase advertising space. As will be appreciated, other types of service providers, such as search engines, e-commerce platforms, news, media or streaming services, and the like, are also contemplated.

Accordingly, a resource manager at the entity operating the client device 108 may use the client device 108 to allocate resources to each of the service providers. The client device 108 may therefore be in communication with the platforms 112, either directly (not shown in the present example) or via the server 104 to allocate resources to the platforms 112.

As will be appreciated, in other examples, the system 100 may include more than one client device 108 and any number n of platforms 112.

In operation the system 100 allows entities (e.g., businesses) to allocate a resource supply amongst the platforms 112 to optimize the return from the resource allocation to the platforms 112. In some examples, the return may be a direct output from the platforms 112, while in other examples, the return may be an indirect result which correlates to the resources allocated to each platform 112. For example, the indirect return may be revenue, which may correlate in different proportions to the resources (e.g., budgetary resources) allocated to each platform 112.

Accordingly, the system 100 further includes a revenue database 116 storing revenue data over time. In particular, the revenue data stored at the revenue database 116 includes both a revenue and/or sales amount, as well as a date and/or time stamp associated with the revenue or sales amount to allow the revenue data to be viewed as a time series. Further, the revenue data may be associated with an account (i.e., a given entity, company, corporation, etc.).

The revenue data may be retrieved from another service provider which provides an e-commerce or other sales platform to the entity associated with a given account. In other examples, the revenue data may be entered or directly retrieved based on the entity's internal records, if no such third-party sales platform is utilized by the entity. As will be appreciated, the revenue database 116 may store an aggregation of revenue data from a plurality of sources based on the platforms and services used by the entity to generate sales. In some examples, the revenue database 116 may be hosted at the server 104, while in other examples, the revenue database 116 may be independently hosted and in communication with the server 104 to allow the server 104 to access the revenue data.

In order to determine how to optimize the allocation of resources, the server 104 may correlate historical revenue data retrieved from the revenue database 116 with historical resource allocation to identify correspondences and trends. Accordingly, the system 100 further includes a resource allocation database 120 storing resource allocation data over time. In particular, the resource allocation data stored at the resource allocation database 120 may include an allocation target identifier identifying the allocation target (e.g., a provider or similar) to which resources were allocated, a resource amount which was allocated to the allocation target, as well as a date and/or time stamp associated with the allocation target and resource amount to allow the resource allocation data to be viewed as a time series. The resource allocation data may additionally be associated with an account.

For example, the resource allocation data may be retrieved from another platform, namely one of the platforms 112, to which resources were allocated. In other examples, the resource allocation may be determined directly based on the entity's internal records of resource allocation. As will be appreciated, the resource allocation database 120 may store an aggregation of resource allocation data from a plurality of sources based on the platforms 112 to which resources are allocated and the manner of tracking the resource allocation. In some examples, the resource allocation database 120 may be hosted at the server 104, while in other examples, the resource allocation database 120 may be independently hosted and in communication with the server 104 to allow the server 104 to access the resource allocation data.

With the revenue data time series and the resource allocation data time series for a given account, the server 104 can correlate revenue with resource allocation to determine effectiveness metrics, as well as developing models to predict future revenue. Accordingly, the system 100 further includes a model database 124. The models may be univariate (e.g., based solely on a single variable, such as revenue), or multivariate (e.g., based on multiple variables, such as both revenue and one or more resource allocations to allocation targets). The server 104 may train the models using one or more artificial intelligence engines. The model database 124 may be hosted at the server 104 or may be independently hosted and in communication with the server 104 to allow the server 104 to access the models.

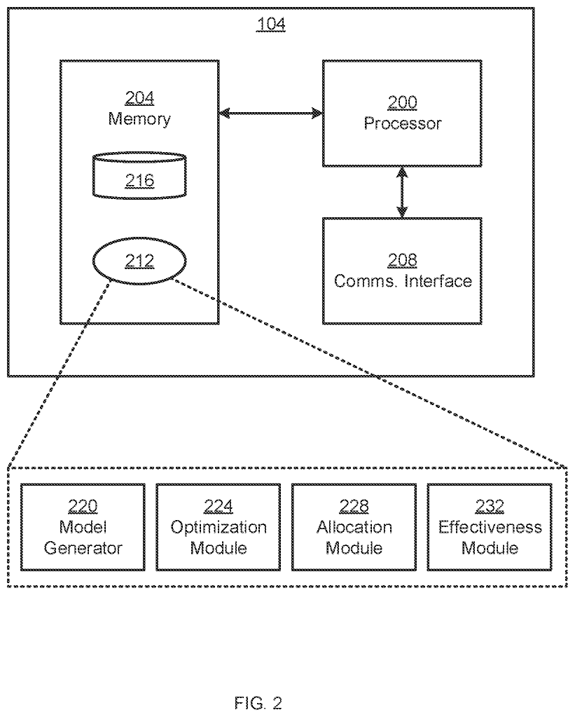

Turning now to FIG. 2, certain internal components of the server 104 are depicted in greater detail. The server 104 includes a processor 200, a memory 204 and a communications interface 208.

The processor 200 may include a central processing unit (CPU), a microcontroller, a microprocessor, a processing core, a field-programmable gate array (FPGA), or similar. The processor 200 may include multiple cooperating processors. The processor 200 may cooperate with the memory 204 to realize the functionality described herein.

The memory 204 may include a combination of volatile (e.g., Random Access Memory or RAM) and non-volatile memory (e.g., read-only memory or ROM, Electrically Erasable Programmable Read Only Memory or EEPROM, flash memory). All or some of the memory 204 may be integrated with the processor 200. The memory stores applications, each including a plurality of computer-readable instructions executable by the processor 200. The execution of the instructions by the processor 200 configures the server 104 to perform the actions discussed herein. In particular, the applications stored in the memory 204 include a resource allocation application 212. When executed by the processor 200, the application 212 configures the processor 200 to perform various functions discussed below in greater detail and related to the resource allocation operation of the server 104.

The memory 204 also stores a repository 216 storing rules and data for the resource allocation operation. For example, the repository 216 may store account information associated with each client (e.g., entity operating a client device 108). The account information may include an account identifier, and relevant associated identifiers to allow access to the revenue data at the revenue database 116, the resource allocation data at the resource allocation database 120, and the predictive models at the model database 124. In some examples, the account information may additionally include tokens, passkeys, and the like to allow the server 104 to interact with various third-party platforms to retrieve the revenue data and the resource allocation data and/or to apply resource allocations.

The application 212 stored in the memory 204 includes a model generator 220, an optimization module 224, an allocation module 228, and an effectiveness module 232. As used herein, the modules of application 212 may be said to perform various actions discussed herein via execution of the instructions contained therein by the processor 200.

In particular, the model generator 220 is generally configured to use historical data to train predictive models. For example, the model generator 220 may use the historical revenue data for a given account from the revenue database 116 to generate a univariate revenue model for the account which may predict revenue at points in time in the future. The model generator 220 may also use the historical revenue data for a given account in consideration of historical resource allocation for the given account to generate a multivariate revenue model for the account which may also predict revenue at points in time in the future. The model generator 220 may employ one or more artificial intelligence engines to generate the univariate and multivariate revenue models.

In some examples, the model generator 220 may additionally train other predictive models. For example, the server 104 may be configured to apply labels to effectiveness metrics, extract features from freeform content (e.g., emails, SMS (short message service) messages, social media posts and the like), apply labels to the extracted features, and the like to allow the freeform content to be quantifiably analyzed and modelled. That is, the model generator 220 may generate predictive models based, for example, on an amount of freeform content generated, certain features of the freeform content (e.g., length of content, subject matter of particular extracted features, etc.), values of the effectiveness metrics, and the like, which may correlate revenue to the effectiveness metrics and/or the freeform content.

The optimization module 224 is configured to perform the optimization of the resource supply. That is, the optimization module 224 is configured to determine an optimal resource allocation to maximize the revenue model based on certain constraints. In particular, the optimization module 224 uses the multivariate model generated by the model generator 220 and stored at the model database 124 and applies an analytical approach to determining the optimal allocation. This is in contrast to purely simulation-based optimization, in which optimization modules select thousands of solutions and run simulations on each solution to identify the optimal solution of the selection. As will be described further below, the analytical approach to selecting a subset of solutions and determining the optimal solution reduces the time and computational complexity of the optimization problem and allows the server 104 to function more efficiently.

The allocation module 228 takes the results of the optimization and applies the determined allocation to the platforms 112.

The effectiveness module 232 obtains time series of the resource allocation data and the revenue data and generates a score to determine the effectiveness of the resource allocation over that time period. In particular, the effectiveness score may represent the strength of the correlation between the resource allocation and the revenue, and therefore, may provide a broad indication of whether resource allocation to that platform, or in that manner provides a positive contribution to revenue. The effectiveness module 232 may be configured to measure the effectiveness of both quantitative resource allocations (e.g., time or money expenditure), as well as qualitative features of freeform content (e.g., emails, social media content, etc.).

The application 212 may also be implemented as a suite of distinct applications. Further, some or all of the functionality of the application 212 may be implemented as dedicated hardware components, such as one or more FPGAs or application-specific integrated circuits (ASICs).

The server 104 further includes the communications interface 208 interconnected with the processor 200. The communications interface 208 may be configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the server 104 to communicate with other computing devices. The specific components of the communications interface 208 are selected based on the types of communication links that the server 104 communicates over.

The server 104 may further include one or more input and/or output devices (not shown). The input devices may include one or more buttons, keypads, touch-sensitive display screen, mice, or the like for receiving input from an operator. The output devices may include one or more display screens, monitors, speakers, sound generators, vibrators, or the like for providing output or feedback to an operator.

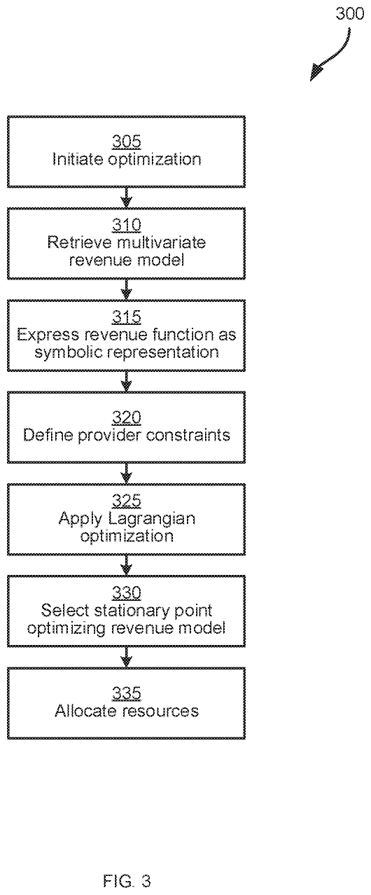

Turning now to FIG. 3, the functionality implemented by the server 104 will be discussed in greater detail. FIG. 3 illustrates a method 300 of optimizing a resource allocation. The method 300 will be discussed in conjunction with its performance in the system 100, and particularly by the server 104, via execution of the application 212. In particular, the method 300 will be described with reference to the components of FIGS. 1 and 2. In other examples, the method 300 may be performed by other suitable devices or systems.

At block 305, the optimization is initiated. The optimization may be initiated, for example, in response to user input at the client device 108. For example, the user may interact with a web interface and select a button to send an optimization request to the server 104. As part of the optimization request, the user may select a set of allocation targets (e.g., providers and/or platforms 112) amongst which to optimize the resource allocation, as well as defining a total resource supply (e.g., a budgetary amount) available for allocation.

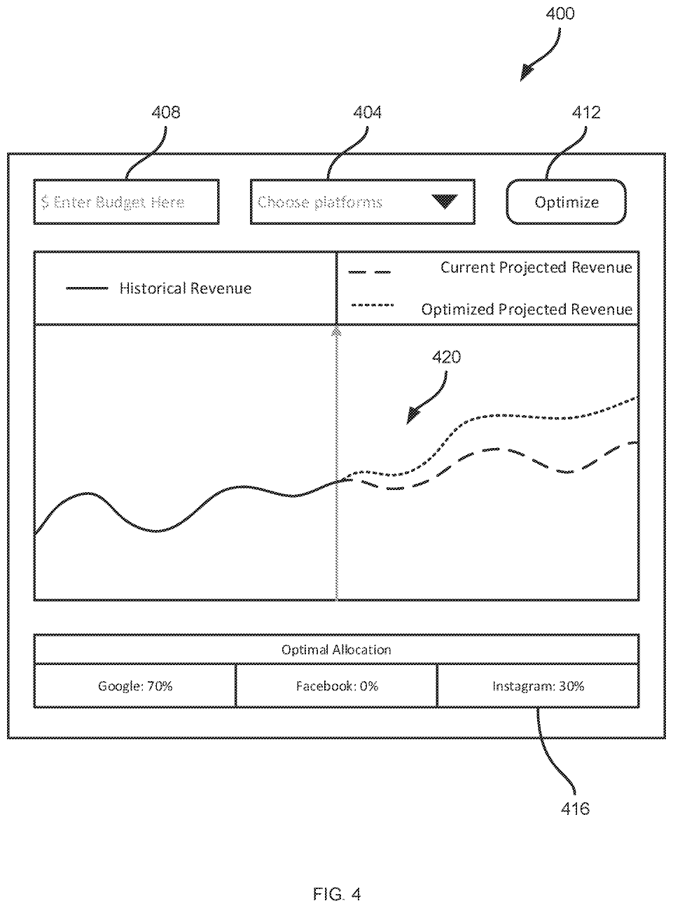

For example, referring to FIG. 4, an example optimization interface 400 is depicted. In the example of FIG. 4, the available resource supply is a budget represented by a dollar amount, and the allocation targets are provider platforms 112 on which advertising space may be purchased. The optimization interface 400 may be presented, for example, at a display at the client device 108. The optimization interface 400 includes a provider selection 404 and an available resource supply entry 408.

The provider selection 404 may list the providers currently associated with the account of the user. That is, the providers listed may include platforms 112 on which the user has previously or is currently purchasing advertising space. In other examples, the providers listed may include a broader selection, such as providers or platforms 112 interconnected with the server 104, and which is not currently associated with the user and/or account. The provider selection 404 is depicted in the present example as a dropdown menu, from which multiple providers may be selected. In other examples, the provider selection 404 may be presented with a set of multi-selectable icons, checkboxes, and other suitable selection mechanisms.

The available resource supply entry 408 allows a user to enter the available resource supply as a quantifiable numeric amount. Accordingly, the available resource supply entry 408 is a text box in which the user may enter a numeric amount corresponding to the available resource supply (e.g., budget). In some examples, the server 104 may provide a predicted available resource supply, based, for example on historical resources available for allocation. In still further examples, the available resource supply entry 408 may be a dropdown list including predefined available resource supply options, or other suitable entry mechanisms.

When both the provider selection 404 and the available resource supply entry 408 include suitable data, the optimization interface 400 may make available a request function 412, depicted in the present example as a clickable button. When the user selects the request function 412, the client device 108 sends an optimization request to the server 104 to initiate the optimization. In particular, the optimization request may include an indication of the providers selected (e.g., based on provider identifiers) and an indication of the resource supply available for allocation (e.g., as entered in the available resource supply entry 408). Upon receipt of the optimization request, the server 104 may initiate the optimization operation.

Returning to FIG. 3, in other examples, at block 305, the optimization operation may be initiated based on threshold conditions detected by the server 104. For example, the server 104 may compute effectiveness metrics of various resource allocations, including specific campaigns and allocations to each platform 112 as well as effectiveness metrics of freeform content, such as social media presence or posts, email and text (e.g., short message service) message outreach, and the like. Based on the thresholds of such effectiveness metrics, the server 104 may automatically initiate an optimization operation to determine whether a more optimal resource allocation is available.

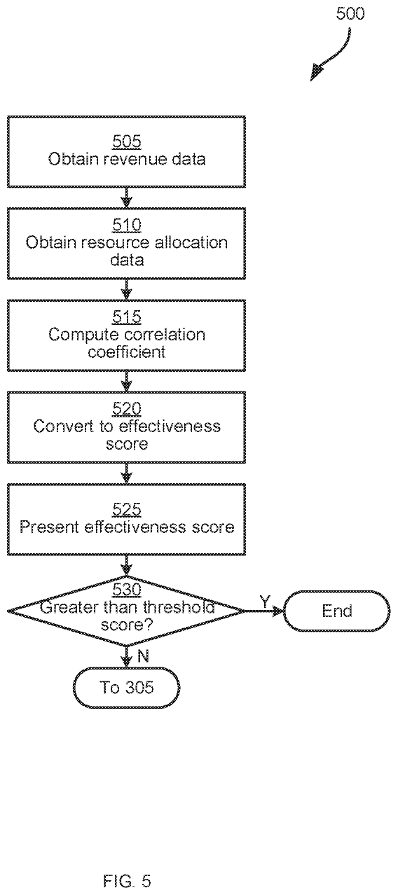

For example, referring to FIG. 5, a flowchart of an example method 500 of computing effectiveness metrics is depicted. The method 500 will be described in conjunction with its performance in the server 104, via execution of the application 212, and in particular, the effectiveness module 232. In other examples, other suitable devices and/or systems may perform the method 500.

At block 505, the server 104 obtains revenue data from the revenue database 116. In particular, the server 104 may obtain the revenue data as a time series. In some examples, based on the parameters of the effectiveness score being computed, the server 104 may retrieve the revenue data filtered based on a certain date or time range. For example, when evaluating the efficacy of a given advertising campaign over a defined time period, the server 104 may retrieve the revenue data corresponding to that time period. In some examples, in addition to the defined time period, the server 104 may retrieve the revenue data corresponding to a predefined amount of time after completion of the defined time period (i.e., since the advertising campaign may encourage revenue incurred after completion of the advertising campaign). In other examples, the server 104 may simply retrieve the revenue data over a predefined period of time prior to the request (e.g., in the past 3 months, 6 months, 1 year, etc.).

At block 510, the server 104 obtains resource allocation data from the resource allocation database 120. The server 104 may similarly obtain the resource allocation data as a time series. In some examples, the resource allocation data may similarly be retrieved and/or filtered by the server 104 based on parameters of the effectiveness score being computed, or simply based on a predefined period of time prior to the request. The server 104 may additionally perform some preprocessing operations on the resource allocation data obtained from the resource allocation database 120.

The content of the resource allocation data and the preprocessing operations performed on the resource allocation data may additionally vary based on the parameters of the effectiveness score being computed. For example, for an advertising effectiveness (or another monetarily quantifiable resource), the resource allocation data may include expenditure for advertising across all platforms 112. The server 104 may preprocess the resource allocation data, for example, to sum the expenditure across platforms to obtain a total expenditure in order to compute an effectiveness score of advertising expenditure for the client account. In other examples, the server 104 may maintain separate time series of advertising expenditure across the platforms 112 to evaluate individual effectiveness across the platforms 112.

In other examples, such as when the effectiveness metrics being evaluated are related to freeform content outreach, the resource allocation data retrieved from the resource allocation database 120 may include the freeform content itself, as well as any quantifiable metrics associated with the freeform content, such as an amount of time and/or expenditure spent to develop and deliver the freeform content, or the like.

The server 104 may preprocess the resource allocation data to analyze the freeform content. For example, for email or SMS messaging, the server 104 may extract contextual features included in the email or SMS message, user identifiers of the recipients, times sent, and the like. Additionally, the server 104 may determine holistic metrics of the emails and SMS messages, such as a total number of emails and SMS messages sent, and the like. In some examples, the server 104 may aggregate the extracted features and metrics into a single representative metric and/or feature of the freeform content. In other examples, the various features and metrics of the freeform content may be evaluated separately to analyze the effectiveness of particular features of the freeform content.

For social media posts, the server 104 may extract contextual features such as story reactions, including a number of exits, impressions, reaches, taps, replies, or other interactions with the social media post. The server 104 may additionally extract audience demographics, including for example, an age, location, and gender of viewers of the social media post. The server 104 may additionally extract post statistics, such as the datetime of the post, likes, comments, shares, email contacts, phone contacts, text messages, and website clicks in response to the social media post. The server 104 may additionally extract media engagement metrics, such as likes, comments, shares, reaches, impressions, and the like in response to the social media post. As will be appreciated, other metrics of responses to the social media post are also contemplated, and the in some examples, certain responses may contribute to multiple features of the social media post (e.g., likes contribute to both post statistics and media engagement). After analyzing the features of the social media post, in some examples, the server 104 may aggregate the extracted features to a single representative metric and/or feature of the social media content. In other examples, the various features and metrics of the social media content may be evaluated separately to analyze the effectiveness of particular features of the social media content.

At block 515, the server 104 compares the revenue data time series and the resource allocation data time series and computes a correlation coefficient. For example, the server 104 may compute the Pearson correlation coefficient or other suitable metrics to measure the correlation between the revenue data and the resource allocation data. In other examples, such as when the resource allocation data includes contextual features rather than quantitative data, other suitable correlation coefficients may be used. In particular, the correlation coefficient is a statistical measure of the strength of the relationship between the revenue data and the resource allocation data, including both quantitative data as well as contextual features. Accordingly, a high correlation coefficient (e.g., closer to 1) generally represents a positive correlation, in which higher allocations or certain contextual features to a given resource corresponds to higher revenue.

In some examples, the server 104 may compute more than one correlation coefficient for the revenue data and the resource allocation data. For example, the server 104 may compute a corresponding correlation coefficient for each platform 112. In other examples, the server 104 may compute correlation coefficients for different contributing factors or features (e.g., of the freeform content) to obtain a more granular effectiveness score of the components which positively contribute to revenue.

At block 520, the server 104 converts the correlation coefficients computed at block 515 to an effectiveness score. The effectiveness score may be, for example, on a scale of 1 to 5, a percentage, or other suitable scoring metrics. As with the correlation coefficients, the server 104 may compute a single effectiveness score, for example for a campaign (e.g., across multiple platforms, and including both advertising and freeform content over a given period of time), for a given platform and/or type of freeform content, on more granular levels based on components of the freeform content, or other relevant factors.

In particular, to compute a single effectiveness score, for example for a campaign, the server 104 may be configured to aggregate multiple correlation coefficients into the single effectiveness score. The server 104 may apply various thresholds to the correlation coefficients, apply mathematical operations, such as obtaining an average, and the like to aggregate the correlation coefficients. The server 104 may additionally scale the aggregated correlation coefficients to the predefined range for the effectiveness score.

As will be appreciated, the effectiveness score generally provides a high-level indication as to how well the campaign, advertising expenditure to a given platform, or other resource allocation being evaluated contributes to increasing revenue for the client account.

At bock 525, the server 104 outputs the effectiveness score generated at block 520. For example, the server 104 may output the effectiveness score to the client device 108 to be presented to the user operating the client device 108.

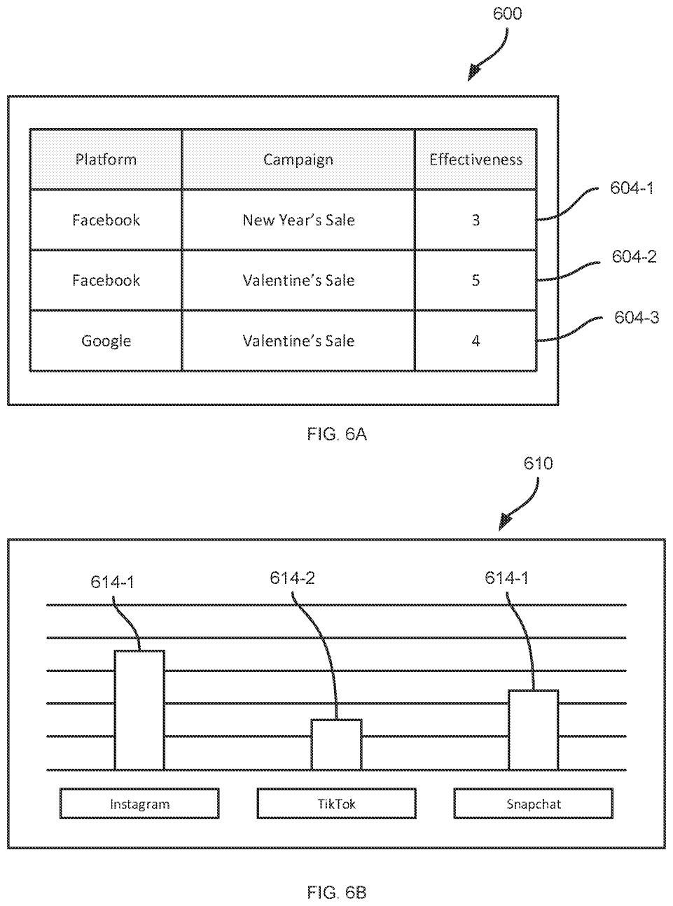

For example, referring to FIG. 6A, an example interface 600 displaying effectiveness scores 604-1, 604-2, and 604-3 is depicted. In particular, each effectiveness score 604 relates to a campaign on a certain platform. As can be seen, the effectiveness scores 604 may differ based on different campaigns. For example, a New Year's Sale campaign may correspond to resource allocation data, including, for example both an advertising expenditure as well as posts on Facebook, and revenue data from a period between mid-December to mid-January of the following year. The server 104 may then compute the effectiveness score 604-1 for that campaign. For the Valentine's Sale campaign, the effectiveness scores 604-2 and 604-3 may track the effectiveness of the same campaign over the same period (e.g., early to mid-February) but across different platforms (i.e., Facebook and Google).

FIG. 6B depicts another example interface 610 displaying effectiveness scores 614-1, 614-2, and 614-3. In this example, the effectiveness scores 614 may relate to social media content posted across three different platforms. In the present example, the effectiveness scores 614 may be displayed in the form of a bar chart rather than numerical values.

In some examples, such as when the effectiveness score is used to initiate an optimization operation, the server 104 may proceed to block 530. At block 530, the server 104 compares the effectiveness score computed at block 520 to a threshold score. The threshold score may be a predefined value stored, for example in the repository 216. For example, when the effectiveness scores range from 1 to 5, the threshold score may be 3. Thus, any effectiveness scores of below 3 may trigger an optimization operation.

Since multiple effectiveness scores may be generated for different resource allocations at block 520, the server 104 may apply some preprocessing to aggregate effectiveness scores (e.g., based on an average effectiveness score). In other examples, the server 104 may have a predefined list of effectiveness scores to evaluate against the threshold score, each of which may trigger an optimization operation.

If the determination at block 530 is affirmative, that is the effectiveness score is above the threshold score, then the method 500 ends. In particular, since the resource allocation being evaluated is sufficiently effective, the server 104 may determine that no reallocation of resources is required.

If the determination at block 530 is negative, that is the effectiveness score is below the threshold score, then the method 500 may proceed to block 305. That is, since the resource allocation is not sufficiently effective, the server 104 may determine that resources should be reallocated and initiate an optimization operation to determine an improved allocation of resources. In such examples, the optimization request may include parameters used for a most recent optimization request. That is, the optimization request may reuse the selected allocation targets used in the current resource allocation or to generate the current resource allocation (i.e., the selected allocation targets may include allocation targets to which no resources are currently allocated, but to which resources may be reallocated as a result of the optimization) and the same available resource allocation (or a computed reduced available resource allocation based on an initial available resource allocation and the resources spent or allocated since the definition of the initial available resource allocation). In other examples, upon detecting that an optimization operation is to be initiated, the server 104 may provide a prompt to the client device 108 for a user to confirm the optimization operation as well as the parameters for the optimization request.

Returning to FIG. 3, at block 310, the server 104 obtains a revenue model associated with the client account from the model database 124. In particular, the revenue model obtained is a multivariate revenue model trained by the model generator 220 based on the historical resource allocation to the platforms 112 and the historical revenue for the account.

At block 315, the server 104 extracts, from the revenue model obtained at block 310, the coefficients corresponding to each allocation target specified in the optimization request at block 305 and expresses the revenue model as a symbolic representation.

For example, the revenue model may be a linear function, such as the one expressed in equation (1):

R(x₁,x₂, . . . ,xₙ)=a₁ƒ₁(x₁)+a₂ƒ₂(x₂)+ . . . +aₙƒₙ(xₙ)+b (1)

In equation (1), R(x₁, x₂, . . . , xₙ) is the revenue function representing the predictive model obtained at block 310. The variables x₁, x₂, . . . , xₙ represent the resource allocations to each of the platforms 112-1, 112-2, . . . , 112-n, respectively. The functions ƒ₁, ƒ₂, . . . , ƒₙ represent the functions defining the contribution to total revenue for each respective platform 112-1, 112-2, . . . , 112-n as a function of the allocation to the respective platform 112. The coefficients a₁, a₂, . . . , aₙ represent the coefficients weighting the contributions of each respective platform 112-1, 112-2, . . . , 112-n to the total revenue. The constant b represents a fixed constant contributing to the revenue function. In other examples, the revenue function R may be a non-linear combination of the functions ƒ₁, ƒ₂, . . . , ƒₙ or other suitable function.

Accordingly, the server 104 may extract the coefficients a₁, a₂, . . . , aₙ, the constant b, as well as any coefficients and/or constants defined in the functions ƒ₁, ƒ₂, . . . ƒₙ.

The server 104 may subsequently use the extracted coefficients to define the symbolic representation of the revenue model. That is, the server 104 may define a new object representative of the revenue function R(x₁, x₂, . . . , xₙ), stored for example in the memory 204, which is a persistent object rather than a function to be evaluated based on inputs of x₁, x₂, . . . , xₙ. The symbolic representation may thus be mathematically manipulated, including to apply a differential to the symbolic representation, without being evaluated with respect to inputs.

At block 320, the server 104 defines target constraints for each of the allocation targets specified in the optimization request at block 305. In particular, the target constraints may relate to constraints on the resource allocation for each allocation target. For example, the resource allocation (i.e., the inputs x₁, x₂, . . . xₙ) may be required to be non-negative, since a negative budget may not be applied to an allocation target. Additionally, the server 104 may define a total budget constraint, such that the sum of the resource allocations (i.e., the inputs x₁, x₂, . . . , xₙ) is equal to the total available resource supply. The target constraints may also be represented as symbolic representations to allow them to be mathematically manipulated.

At block 325, the server 104 applies Lagrangian optimization to revenue function R to obtain a set of stationary points. More particularly, the server 104 computes the Lagrangian function based on the symbolic representation of the revenue model defined at block 315 and the target constraints defined at block 320. The server 104 may then solve the Lagrangian optimization problem with respect to the revenue function R, including by computing the gradients for each of the allocation targets and solving the Karush-Kuhn-Tucker conditions (i.e., since some of the constraints may include inequality conditions). As a result of applying the Lagrangian optimization, the server 104 obtains a set of stationary points. Each stationary point represents a local maximum, and the set of stationary points includes a stationary point corresponding to the global maximum for the revenue function R. Each stationary point defines, for each allocation target, the associated allocation that leads to the local maximum. That is, the stationary point defines values of the inputs x₁, x₂, . . . , xₙ for each of then allocation targets, which lead to a local maximum of the revenue function R.

Further, since there is a non-negativity constraint on the potential input allocations to each allocation target (i.e., a non-negativity constraint on the inputs x₁, x₂, . . . , xₙ), there is also an associated local maximum where the input allocation xᵢ is 0 for the i-th allocation target. Therefore, the set of stationary points is the collection of possible combinations where each allocation is either on the frontier of the non-negativity constraints (i.e., equals 0) or has a determined value set by the stationary point.

At block 330, the server 104 evaluates each of the stationary points from the set to select a stationary point optimizing the revenue model. That is, the stationary point selected from the set is the stationary point corresponding to the global maximum of the revenue function R. Since each stationary point defines an allocation for each allocation target, the resource allocation defined by the stationary point is the resource allocation optimizing the revenue model.

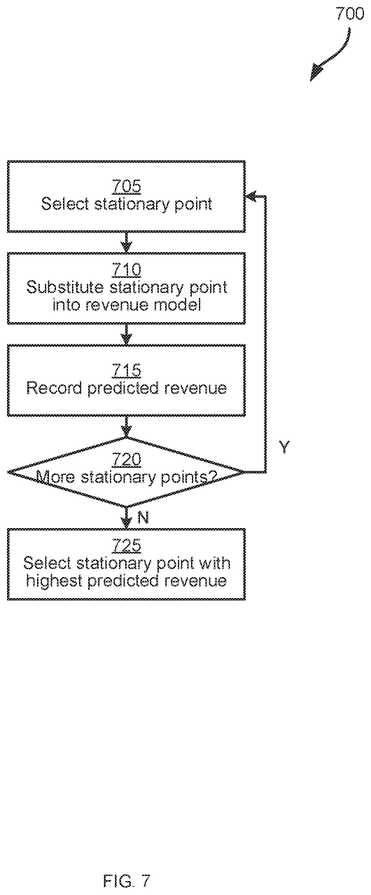

For example, referring to FIG. 7, an example method 700 of running simulations of inputs to the revenue model to select a resource allocation which optimizes the revenue model at block 330 of the method 300.

At block 705, the server 104 selects a stationary point from the set of stationary points. In particular, the server 104 selects a stationary point which has not yet been evaluated to determine its corresponding predicted revenue.

At block 710, the server 104 extracts the resource allocation defined by the stationary point and substitutes the resource allocation for each of the allocation targets into the revenue function R. That is, the server 104 substitutes the resource allocation of the stationary point for a given allocation target i for the variable xᵢ for each of the n allocation targets. The server 104 may then evaluate the result of the revenue function R to obtain a predicted revenue associated with the stationary point selected at block 705.

At block 715, the server 104 stores the predicted revenue determined at block 710 in association with the stationary point. For example, the server 104 may store the predicted revenue in the repository 216, and/or simply in a cache until the optimal stationary point is selected.

At block 720, the server 104 determines whether there are more stationary points in the set for which a predicted revenue has not yet been computed. If the determination at block 720 is affirmative, that is, there are more stationary points which do not yet have an associated predicted revenue, then the method 700 returns to block 705 for the server 104 to pick another stationary point for which to compute the corresponding predicted revenue.

If the determination at block 720 is negative, that is, each of the stationary points in the set have been evaluated to determine the corresponding predicted revenue, then the method 700 proceeds to block 725. At block 725, the server 104 selects, from the set of stationary points, the stationary point having the highest predicted revenue associated with it. The stationary points represent the set of extrema in the revenue function. Therefore, all local maximums are contained within the set of stationary points. These points are iterated through in order to find the global maximum. The extrema that results in the largest predicted revenue is the global maximum.

As will be appreciated, in a purely simulation-based approach to optimization, a method similar to the method 700 may be performed to evaluate revenue for a number of potential solutions. However, the potential solutions tested is not limited, in traditional simulation-based solutions, to the stationary points determined from a Lagrangian optimization problem. Rather, the potential solutions tested are constrained only to the broad constraints on the input (e.g., non-negativity constraints), including the number of possible values for each allocation target (i.e., the number of possible values for the inputs). Accordingly, the time and computational complexity of a purely simulation-based approach is exponential. More particularly, the computational complexity of the purely simulation-based approach is O(iⁿ) time, where i corresponds to the number of possible values of the inputs, and n corresponds to the number of allocation targets. As will be appreciated, the complexity is variable both based on the number of possible inputs i, as well as the number of allocation targets n. As the number of possible inputs i increases, as it may naturally do as the available resource supply increases, and as the number of allocation targets increases, the computational complexity increases as well.

In contrast, the method 700 as described has a limited number of potential solutions to simulate—namely the set of stationary points. Since resource allocations defined by the stationary points may either be defined by the stationary point, or may be on the frontier of the non-negativity constraint (i.e., equals 0), the number of possible values for each input is 2. The computational complexity of running simulations over the set of stationary points is therefor O(2ⁿ) time, where n similarly corresponds to the number of allocation targets. That is, the computational complexity of is exponential with a base constrained to the binary.

As will be appreciated, the limitation of the base of the exponential to the binary allows the server 104 to improve the run-time by reducing the computational complexity of the optimization operation. This limitation is made possible by integrating the application of Lagrangian methods to the revenue optimization problem, which in turn, is made possible by expressing the revenue model as a symbolic representation to allow the server 104 to differentiate and otherwise mathematically manipulate for the application of the Lagrangian methods. Since the computational complexity of both the expression of the revenue model as a symbolic representation and the application of Lagrangian methods is dwarfed by the O(2ⁿ) time of the simulation of the method 700, the overall computational complexity remains O(2ⁿ) time, and hence the integration of these features into the optimization operation improves the functioning of the server 104 over a purely simulation-based approach to an optimization problem.

Returning to FIG. 3, after selecting the stationary point which optimizes the revenue model at block 330, the method 300 proceeds to block 335. At block 335, the server 104 allocates resources to each of the allocation targets according to the resource allocation defined by the selected stationary point. That is, the server 104 may communicate with each of the platforms 112 to adjust the resources contributed to the platform 112.

In some examples, the available resource supply may be an aggregate amount (e.g., an amount to be spent over the course of a month, or a year, etc.). Accordingly, the server 104 may not distribute the entirety of the resource allocation to the platforms 112 immediately. Rather, the server 104 may divide the resource allocation for a given platform 112 into increments based on a time period over which the available resource supply is to be distributed (e.g., 3 months, 6 months, 1 year, etc.), as well as a time interval over which the available resource supply period is to be distributed (e.g., every week, every 2 weeks, etc.). In some examples, the time period and the time interval over which the available resource supply is to be distributed may be specified in the optimization request, while in other examples, the time period and time interval may be determined based on historical resource allocation data.

In addition to allocating the resources at block 335, the server 104 may additionally output the determined optimal resource allocation, for example for presentation at the client device 108. For example, returning to FIG. 4, the optimization interface 400 may additionally include an optimal allocation 416 indicating a percentage (or other representation of the resource allocation) of the available resource supply specified at the entry 408 to be allocated to each of the platforms selected at the provider selection 404. The optimization interface 400 may additionally display a graph 420 displaying the historical revenue, the current projected revenue (i.e., based on the pre-optimized allocation), and the optimized projected revenue (i.e., based on the optimal resource allocation determined by the method 300). In particular, the current and optimized projected revenue may be based on a periodic resource allocation in accordance with the time period and time interval over which the available resource supply is to be distributed.

As will be appreciated, the method 300 may be executed periodically to ensure optimal distribution. For example, the server 104 may be configured to recompute the effectiveness metrics relating to the resource allocation after a predefined time period (e.g., 1 month, 3 months, 6 months, etc.) of application of the optimal resource allocation. The additional resource allocation data and revenue data over the predefined time period may cause a change in the revenue function, which in turn may result in a change in the optimal resource allocation. Accordingly, if the effectiveness metrics indicate a dropping effectiveness score, the server 104 may perform the method 300 to determine a new optimal resource allocation. That is, if the recomputed effectiveness metric is below a threshold score (e.g., the threshold score used in the method 500), then the server 104 may initiate a further instance of the resource allocation optimization operation. In some examples, if the new optimal resource allocation is similar (e.g., within 5% or similar) of the previous resource allocation, and the effectiveness metrics are below a threshold score, the server 104 may provide an indication for presentation, for example at the client device 108, to advise an account manager to review the resource allocation.

As described herein, a system and method for optimizing allocation of a resource supply is provided. First, the system may train and store a multivariate revenue model using historical data, including a time series indication of revenue, and a time series indication of resource allocation per provider or platform which act as additional regressors for the model. The system may then define a symbolic representation of the revenue model and a provision of the allocation target constratings to allow an analytical approach, particularly a Lagrangian approach to the optimization problem, to arrive at a set of stationary points. The set of stationary points is the collection of possible combinations where each allocation is on the frontier of the non-negativity constraint, or is positively defined. Further, each of these stationary points represents a local maximum of the revenue function in view of the target constraints. Accordingly, evaluation of the revenue function for each stationary points yields the global maximum for the revenue function, and hence the corresponding stationary point defines the resource allocation to each allocation target. Advantageously, by leveraging the symbolic representation and the Lagrangian optimization, the simulation space over which the revenue function is to be evaluated is constrained to the set of stationary points, resulting in a computational complexity of O(2ⁿ) time—significantly less than the computational complexity of O(iⁿ) time, with increasing variability of the base i of traditional simulation-based optimization approaches.

After computing the optimal resource allocation, the system may additionally apply the determined resource allocation by determining incremental amounts to apply to each platform, based on a time period and a time interval over which the total available resource supply is to be distributed.

The system may additionally be used to compute effectiveness metrics of resource allocation campaigns, including quantitative amounts, such as advertising budgets or expenditures, as well as for freeform content, such as emails, SMS messages, social media content, and the like. The effectiveness metrics may be used, for example to trigger the optimization operation and/or to interface with the optimization operation over time to ensure continued optimal resource allocation. In other examples, the effectiveness metrics may be to provide analytic information to resource managers at a client or account for which the optimization is being performed.

The scope of the claims should not be limited by the embodiments set forth in the above examples but should be given the broadest interpretation consistent with the description as a whole.

1. A server for resource allocation optimization amongst a plurality of allocation targets, the server comprising:
a memory and a communications interface; and
a processor interconnected to the memory and the communications interface, the processor configured to:
obtain a revenue model associated with an account, the revenue model trained based on a historical resource allocation and revenue for the account;
extract, from the revenue model, coefficients corresponding to each of the allocation targets;
define, using the extracted coefficients, a symbolic representation of the revenue model;
define target constraints for each of the allocation targets based on resource allocation constraints, the target constraints expressed as symbolic representations;
apply Lagrangian optimization to the symbolic representation of the revenue model and the target constraints to obtain a set of stationary points;
evaluate each of the stationary points from the set to select a stationary point optimizing the revenue model, the selected stationary point defining a resource allocation for each of the allocation targets; and
allocate, for each of the allocation targets, resources according to the resource allocation defined by the stationary point.

2. The server of claim 1, wherein the processor is configured to:
receive an optimization request from a client device via the communications interface; and
initiate the resource allocation optimization in response to the optimization request.

3. The server of claim 1, wherein the processor is configured to:
compute an effectiveness metric for a selected resource allocation; and
when the effectiveness metric is below a threshold score, initiate the resource allocation optimization.

4. The server of claim 3, wherein to compute the effectiveness metric, the processor is configured to:
obtain revenue data based on the selected resource allocation;
obtain resource allocation data based on the selected resource allocation;
determine one or more correlation coefficients between the revenue data and the resource allocation data; and
convert the correlation coefficients to the effectiveness metric.

5. The server of claim 4, wherein the processor is further configured to:
extract contextual features from the resource allocation data; and
determine the one or more correlation coefficients between the revenue data and the contextual features of the resource allocation data.

6. The server of claim 3, wherein the processor is further configured to:
after a predefined period of time of allocating the resources according to the resource allocation defined by the stationary point, recompute the effectiveness metric for the selected resource allocation; and
when the recomputed effectiveness metric is below the threshold score, initiate a further instance of the resource allocation optimization.

7. The server of claim 1, wherein to select the stationary point optimizing the revenue model, the processor is configured to:
for each stationary point in the set, substitute the resource allocation defined by the stationary point into the revenue model to obtain an associated predicted revenue; and
select, as the selected stationary point, the stationary point of the set having a highest associated predicted revenue.

8. The server of claim 1, wherein to allocate the resources according to the resource allocation defined by the selected stationary point, the processor is configured to:
obtain a defined time period over which to distribute the resources;
obtain a defined time interval over which to distribute the resources;
define increments of the resource allocation to allocate to the allocation target based on the defined time period and the defined time interval; and
allocate the resource allocation to the allocation target in the defined increments at the defined time interval over the defined time period.

9. A method for resource allocation optimization amongst a plurality of allocation targets, the method comprising:
obtaining a revenue model associated with an account, the revenue model trained based on a historical resource allocation and revenue for the account;
extracting, from the revenue model, coefficients corresponding to each of the allocation targets;
defining, using the extracted coefficients, a symbolic representation of the revenue model;
defining target constraints for each of the allocation targets based on resource allocation constraints, the target constraints expressed as symbolic representations;
applying Lagrangian optimization to the symbolic representation of the revenue model and the target constraints to obtain a set of stationary points;
evaluating each of the stationary points from the set to select a stationary point optimizing the revenue model, the selected stationary point defining a resource allocation for each of the allocation targets; and
allocating, for each of the allocation targets, resources according to the resource allocation defined by the stationary point.

10. The method of claim 9, further comprising:
receiving an optimization request from a client device; and
initiating the resource allocation optimization in response to the optimization request.

11. The method of claim 9, further comprising:
computing an effectiveness metric for a selected resource allocation; and
when the effectiveness metric is below a threshold score, initiating the resource allocation optimization.

12. The method of claim 11, wherein computing the effectiveness metric comprises:
obtaining revenue data based on the selected resource allocation;
obtaining resource allocation data based on the selected resource allocation;
determining one or more correlation coefficients between the revenue data and the resource allocation data; and
converting the correlation coefficients to the effectiveness metric.

13. The method of claim 12, further comprising:
extracting contextual features from the resource allocation data; and
determining the one or more correlation coefficients between the revenue data and the contextual features of the resource allocation data.

14. The method of claim 11, further comprising:
after a predefined period of time of allocating the resources according to the resource allocation defined by the stationary point, recomputing the effectiveness metric for the selected resource allocation; and
when the recomputed effectiveness metric is below the threshold score, initiating a further instance of the resource allocation optimization.

15. The method of claim 9, wherein selecting the stationary point optimizing the revenue model comprises:
for each stationary point in the set, substituting the resource allocation defined by the stationary point into the revenue model to obtain an associated predicted revenue; and
selecting, as the selected stationary point, the stationary point of the set having a highest associated predicted revenue.

16. The method of claim 9, wherein allocating the resources according to the resource allocation defined by the selected stationary point comprises:
obtaining a defined time period over which to distribute the resources;
obtaining a defined time interval over which to distribute the resources;
defining increments of the resource allocation to allocate to the allocation target based on the defined time period and the defined time interval; and
allocating the resource allocation to the allocation target in the defined increments at the defined time interval over the defined time period.

17. A system for resource allocation optimization amongst a plurality of allocation targets, the system comprising:
a revenue database storing revenue data for at least one account;
a resource allocation database storing resource allocation data for the account;
a model database storing revenue models for the account, the revenue models trained based on the revenue data and the resource allocation data; and
a server configured to:
obtain a revenue model from the model database;
extract, from the revenue model, coefficients corresponding to each of the allocation targets;
define, using the extracted coefficients, a symbolic representation of the revenue model;
define target constraints for each of the allocation targets based on resource allocation constraints, the target constraints expressed as symbolic representations;
apply Lagrangian optimization to the symbolic representation of the revenue model and the target constraints to obtain a set of stationary points;
evaluate each of the stationary points from the set to select a stationary point optimizing the revenue model, the selected stationary point defining a resource allocation for each of the allocation targets; and
allocate, for each of the allocation targets, resources according to the resource allocation defined by the stationary point.

18. The system of claim 17, further comprising a client device associated with the account, wherein the server is configured to:
receive an optimization request from the client device; and
initiate the resource allocation optimization in response to the optimization request.

19. The system of claim 17, wherein the server is configured to:
compute an effectiveness metric for a selected resource allocation; and
when the effectiveness metric is below a threshold score, initiate the resource allocation optimization.

20. The system of claim 19, wherein to compute the effectiveness metric, the server is configured to:
obtain a subset of the revenue data based on the selected resource allocation;
obtain a subset of the resource allocation data based on the selected resource allocation;
determine one or more correlation coefficients between the subset of the revenue data and the subset of the resource allocation data; and
convert the correlation coefficients to the effectiveness metric.

21. The system of claim 20, wherein the server is further configured to:
extract contextual features from the subset of the resource allocation data; and
determine the one or more correlation coefficients between the subset of the revenue data and the contextual features of the subset of the resource allocation data.

22. The system of claim 19, wherein the server is further configured to:
after a predefined period of time of allocating the resources according to the resource allocation defined by the stationary point, recompute the effectiveness metric for the selected resource allocation; and
when the recomputed effectiveness metric is below the threshold score, initiate a further instance of the resource allocation optimization.

23. The system of claim 17, wherein to select the stationary point optimizing the revenue model, the server is configured to:
for each stationary point in the set, substitute the resource allocation defined by the stationary point into the revenue model to obtain an associated predicted revenue; and
select, as the selected stationary point, the stationary point of the set having a highest associated predicted revenue.

24. The system of claim 17, wherein to allocate the resources according to the resource allocation defined by the selected stationary point, the server is configured to:
obtain a defined time period over which to distribute the resources;
obtain a defined time interval over which to distribute the resources;
define increments of the resource allocation to allocate to the allocation target based on the defined time period and the defined time interval; and
allocate the resource allocation to the allocation target in the defined increments at the defined time interval over the defined time period.
